(19) United States
(12) Patent Application Publication
(10) Pub. No.: US 2010/0155410 A1
(43) Pub. Date: Jun. 24, 2010

(54) MULTI-PURPOSE PRODUCT DISPENSER

(76) Inventor: Gerald J. Keberlein, Hortonville, WI (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(21) Appl. No.: 12/640,190

(22) Filed: Dec. 17, 2009

Related U.S. Application Data
(60) Provisional application No. 61/203,061, filed on Dec. 18, 2008.

(51) Int. Cl. B65D 83/08; B65D 83/00; B65D 83/04; B23P 11/00

(52) U.S. Cl. 221/34; 221/92; 29/428

(57) ABSTRACT

A product dispenser that includes a blank that is segregated into sections, wherein the sections are folded to form a first product dispensing portion for dispensing a first product, a second product dispensing portion for dispensing a second product, and a cover portion that is configured to receive signage, and wherein the cover portion at least partially encloses both the first product dispensing portion and the second product dispensing portion.

### CROSS-REFERENCE TO RELATED APPLICATIONS

This application claims priority to U.S. Provisional Application Ser. No. 61/203,061 filed on Dec. 18, 2008, titled Multi-Purpose Product Dispenser, which is incorporated by reference in its entirety herein.

### STATEMENT REGARDING FEDERALLY SPONSORED RESEARCH OR DEVELOPMENT

None

### FIELD OF THE INVENTION

The present invention relates generally to product dispensers and more particularly to dispensers that are capable of dispensing a plurality of products.

### BRIEF SUMMARY OF THE INVENTION

In one aspect, the present invention relates to a product dispenser that includes, a blank that is segregated into sections, wherein the sections are folded to form a first product dispensing portion for dispensing a first product, a second product dispensing portion for dispensing a second product, and a cover portion that is configured to receive signage. In addition, the cover portion at least partially encloses both the first product dispensing portion and the second product dispensing portion. In another aspect, the blank is a single continuous piece of material.

In yet another aspect, the present invention relates to a product dispenser that includes, a first section having at least one of a first section left flap portion and a first section right flap portion, and a slot formed therethrough for accessing a first product, and a second section having at least one of a second section left flap portion and a second section right flap portion, the second section connected to the first section by at least one of a front wall section and an end wall section. In addition, the front wall section includes at least one of a front wall left flap portion and a front wall right flap portion and the back wall section includes at least one of a back wall left flap portion and a back wall right flap portion. Additionally, the securing of one or more of the first section flap portions, second section flap portions, front wall flap portions and back wall flap portions to each other provides an enclosure for the first product, a third section connected to at least one of the back wall section and the front wall section, where the third section forms at least a portion of a cover. The product dispenser further includes, a fourth section having a plurality of apertures for receiving a plurality of trays at least partially therethrough, where the fourth section is connected to the third section, and a fifth section having an opening for removing a second product situated in the trays when the fifth section is folded over the fourth section, where the fifth section and fourth sections form at least a portion of the cover and are capable of securing the trays when folded together, and whereby the cover is capable of covering the slot.

In still another aspect, the present invention relates to a method of forming a multi-purpose product dispenser, the method including, providing a continuous blank having a pill-dispenser portion and a tissue-dispenser portion, where the tissue-dispenser portion is connected to the pill-dispenser portion at least partially by a cover portion; and assembling the multi-purpose product dispenser by folding at least a portion of each of the pill-dispenser portion, the tissue-dispenser portion and the cover portion.

In still another aspect, the present invention relates to a method of forming a product dispenser for pills and paper products that includes the following steps: (1) folding one or more flap portions of a first section of a blank, the first section having a slot formed therethrough for accessing a paper product; (2) folding one or more flap portions of a second section of the blank, the second section being connected to the first section by at least one of a front wall section and an end wall section of the blank; (3) folding one or more flap portions of the front wall section and the back wall section; (4) securing one or more of the first section flap portions, the second section flap portion, front wall flap portions and back wall flap portions to each other to enclose a plurality of paper products; (5) abuttingly positioning a pill package that includes one or more trays containing a plurality of pills against a fourth section of the blank, the fourth section having a plurality of apertures for receiving the plurality of trays at least partially therethrough, wherein the fourth section is connected to a third section; (6) folding a fifth section of the blank that is connected to the fourth section, such that the pill package is secured therebetween, wherein the fifth section includes an opening for removing a plurality of pills situated in the trays, and the fourth section is connected to a third section of the blank; (7) folding the combined fifth section and fourth section onto the third section; and (8) folding the combined fifth section, fourth section and third section onto the first section.

Other embodiments, aspects, features, objectives and advantages of the present invention will be understood and appreciated upon a full reading of the detailed description and the claims that follow.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. The drawings illustrate a best mode presently contemplated for carrying out the invention. Like reference numerals are used to indicate like components. In the drawings:

FIG. 1 is a perspective view of an exemplary product dispenser in accordance with at least some embodiments of the present invention;

FIG. 2 is a top view of the product dispenser of FIG. 1 in an unassembled form;

FIG. 3 is a perspective view of the product dispenser of FIG. 2 in a partially assembled form with an exemplary pill pack situated adjacent thereto;

FIG. 4 is a perspective view of the product dispenser of FIG. 3, with the pill pack shown abutted against the product dispenser;

FIGS. 5A and 5B are perspective views of the product dispenser of FIG. 4, with a fifth section in progressively folded positions;

FIGS. 5C and 5D are perspective views of the product dispenser of FIG. 5B, with an exemplary pill-dispenser portion fully assembled;

FIGS. 6A and 6B are perspective views of the product dispenser of FIG. 5D, with a fourth section of the product dispenser in partially folded positions; and

FIGS. 7A and 7B are perspective views of the product dispenser of FIG. 6B, with a cover of the product dispenser in partially closed positions.

### DETAILED DESCRIPTION OF THE PREFERRED EMBODIMENT

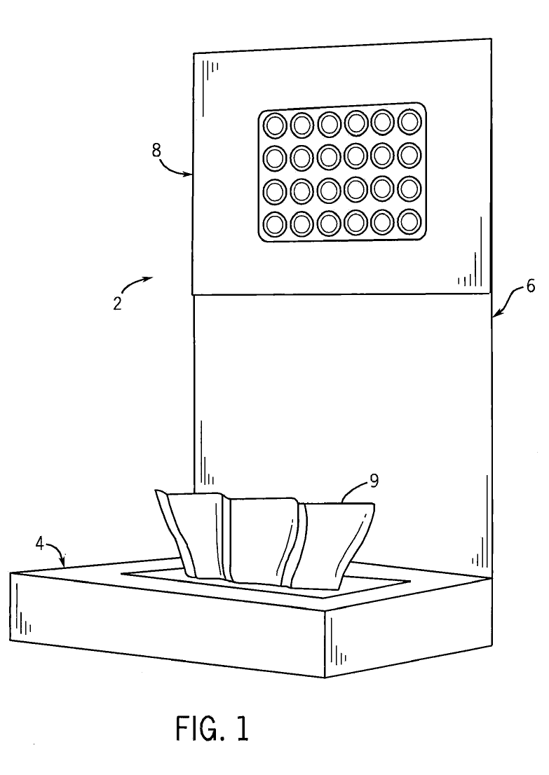

FIG. 1 depicts an assembled multi-purpose product dispenser 2 that includes a tissue-dispenser portion 4, a cover portion 6, and a pill-dispenser portion 8. The tissue-dispenser portion 4 provides an enclosure for holding and dispensing various paper products, for example, disposable facial tissues 9 and moist wipes. The pill-dispenser portion 8 provides a securing position for pre-packaged pills (as described below). The cover portion 6 forms part of a cover (as described below) that substantially protects both the tissue-dispenser portion 4 and the pill-dispenser portion 8, as well as providing two faces (as described below) that can be utilized as surfaces for receiving signage (e.g. indicia). Stated another way, such surfaces are referred to as “signage receiving surfaces”.

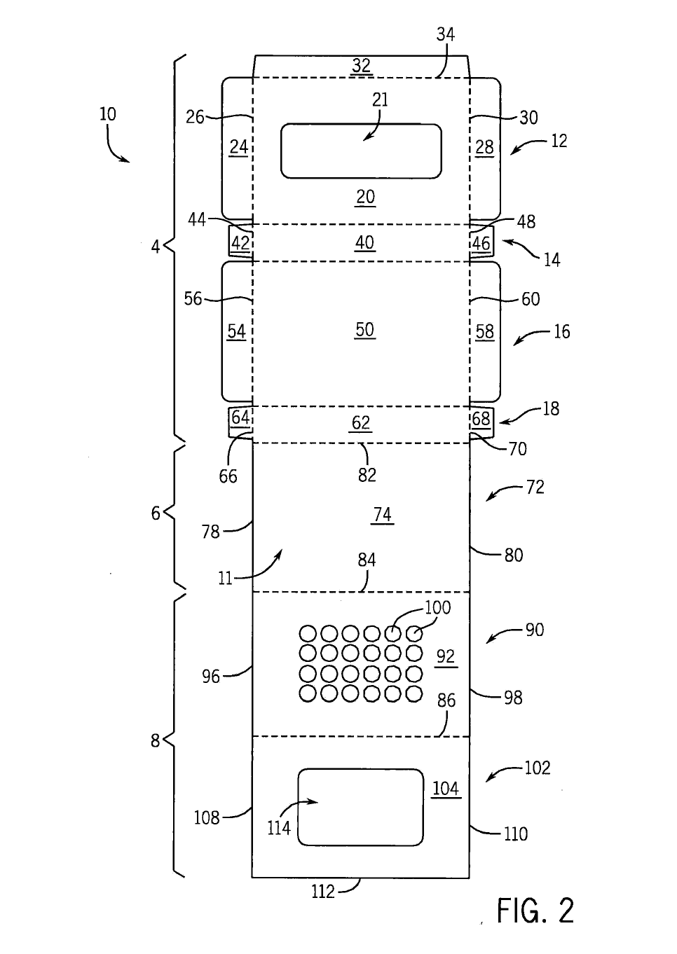

Referring to FIG. 2, the product dispenser 2 is shown in an unassembled form as a die or blank 10 in accordance with at least some embodiments of the invention. The blank 10 is configured to allow for the product dispenser 2 to be formed from a single piece of material. The blank 10 has a surface 11 that is substantially planar and extends along the length and width of the blank 10. The blank 10 is further segregated into sections (as discussed below) that are used to form the tissue-dispenser portion 4, the cover portion 6 and the pill-dispenser portion 8.

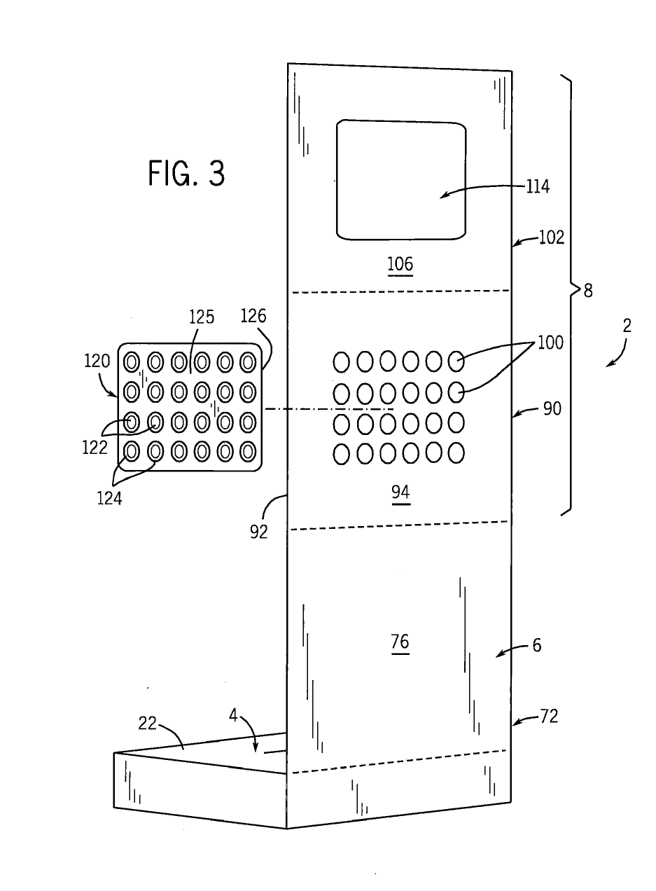

Further referring to FIG. 2, the tissue-dispenser portion 4 comprises a first section 12, a front wall section 14, a second section 16, and an end wall section 18. The first section 12 includes a first section bottom face 20 with an opening or slot 21 extending therethrough, a first section top face 22 (shown in FIG. 3), a left flap portion 24 at a first end 26, a right flap portion 28 at a second end 30, and a tab portion 32 at a third end 34. The first section 12 is contiguous with the front wall section 14. The front wall section 14 includes a wall portion 40, a left flap portion 42 at a first end 44, and a right flap portion 46 at a second end 48. The front wall section 14 is contiguous with the second section 16. The second section 16 includes a second section bottom face 50, a second section top face opposite the bottom face (not shown), a left flap portion 54 at a first end 56, a right flap portion 58 at a second end 60. The second section 16 is contiguous with the back wall section 18. The back wall section 18 includes a wall portion 62, a left flap portion 64 at a first end 66, and a right flap portion 68 at a second end 70. When assembled, the sections 12, 14, 16, 18 form the tissue-dispenser portion 4 for providing facial tissues 9 (FIG. 1). In addition, the term “facial tissue” is used herein with reference to the invention, although it is noted that the invention can include any of a variety of products such as paper-based and cloth-based products.

Further referencing FIG. 2, the cover portion 6 comprises the third section 72, wherein the third section 72 is contiguous with the back wall section 18 along line 82. The third section 72 includes a third section bottom face 74, a third section top face 76 (shown in FIG. 3), wherein both faces 74, 76 extend to a first end 78 and a second end 80. The cover portion 6 is configured to allow for the application of signage that is visible on the product dispenser 2 when assembled. In addition, the cover portion 6 connects the tissue-dispenser portion 2 with the pill-dispenser portion 8.

The pill-dispenser portion 8 comprises a fourth section 90 and a fifth section 102, wherein the fourth section 90 is contiguous with the third section 72 along line 84 and the fifth section 102 is contiguous with the fourth section 90 along line 86. The fourth section 90 includes a fourth section bottom face 92, and a fourth section top face 94 (shown in FIG. 3), wherein both faces 92, 94 extend to a first end 96 and a second end 98. Further, in the present embodiment, the fourth section 90 includes a plurality of apertures 100 extending through both faces 92, 94. It is contemplated that apertures of other sizes, shapes and locations are contemplated herein.

The fifth section. 102 includes a fifth section bottom face 104 and a fifth section top face 106 (shown in FIG. 3), wherein both faces 104, 106 extend to a first end 108 and a second end 110. Further, in the present embodiment, the fifth section 102 includes a top end 112, and an opening 114 that extends through both faces 104, 106.

In at least some embodiments, to form the product dispenser 2, the blank 10 is cut, stamped or otherwise formed from a substantially planar material, such as a paper-based material, for example, Solid Bleached. Sulfate (SBS) paper-board. (e.g. cardstock). The sections 12, 14, 16, 18, 72, 90, 102 are folded to form each of the tissue-dispenser portion 4, the cover portion 6, and the pill-dispenser portion 8. More specifically, in at least one embodiment, to assemble the tissue-dispenser portion 4, each of the left flap portions 24, 42, 54, 64, the right flap portions 28, 46, 58, 68 and the tab portion 32 are folded in an upward direction relative to the surface 11 of the blank 10, such that they are situated at a substantially perpendicular angle relative to the surface 11. An adhesive is applied to one or more of the flap portions, and a plurality of facial tissues 9 are placed on the second section bottom face 50. The first section 12 is then folded such that the first section bottom face 20 is at a substantially perpendicular angle relative to the wall portion 40. The front wall section 14 (along with the first section 12) is then folded such that the wall portion 40 is at a substantially perpendicular angle to the second section bottom face 50, thereby positioning the first section bottom face 20 substantially parallel with the second section bottom face 50. Finally, the second section 16 is folded (along with the other folded sections 12, 14) such that the second section bottom face 50 is at a substantially perpendicular angle to the back wall portion 62. Once the sections 12, 14, 16 are folded, the flaps associated with each section are folded perpendicular to their respective section surfaces, such that one or more of the flaps at least partially overlap with an adjacent flap. The aforementioned adhesive serves to secure the left flap portions 24, 42, 54, 64 at least indirectly to each other and the right flap portions 28, 46, 58, 68 at least indirectly to each other. Further, the tab portion 32 is secured by an adhesive to the back wall portion 62. Although the tissue-dispenser portion 4 is described as being assembled prior to the pill-dispenser portion 8, the tissue-dispenser portion 4 can be assembled either before or after the pill-dispenser portion 8 is assembled.

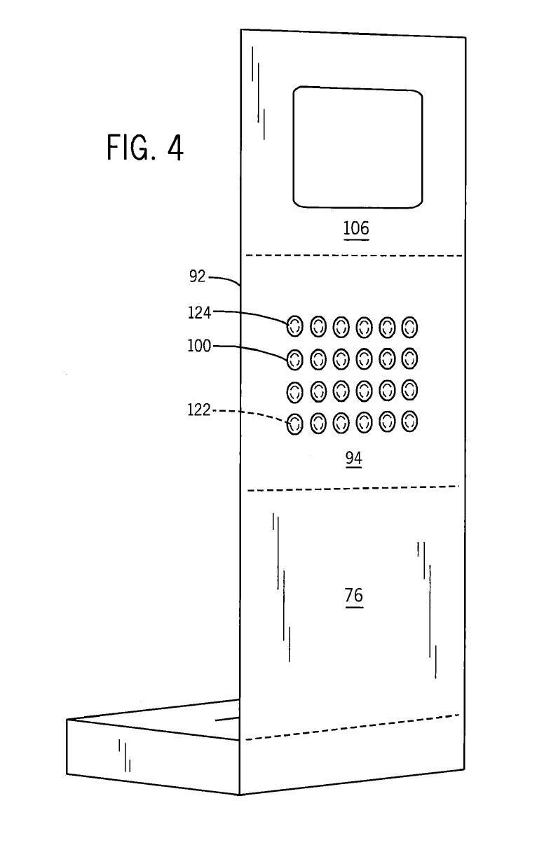

In reference to FIGS. 3 and 4, the product dispenser 2 is depicted with the tissue-dispenser portion 4 assembled, the pill-dispenser portion 8 unassembled, and the cover portion 6 situated therebetween the portions 4, 8. The pill-dispenser portion 8 is configured to house pills in a secure, yet convenient, manner. In general, pill manufacturers utilize various types of packaging for pills. One such type of packaging is a blister package 120 as shown in FIG. 3. This type of packaging provides one or more pills 122 situated individually in trays 124. For simplicity, the term “pill” is used herein with reference to the invention. However, it is noted that the invention is contemplated for use with regard to any of a variety of pill or pill-like structures.

The trays 124 extend from a package surface 125 and are comprised of a material such as a plastic film that has a penetration threshold that is substantially greater than a backing material 126. The backing material 126 is comprised of a material such as, metal foil or paper, and is secured to the tray 124 opposite the package surface 125, thereby encapsulating the pills 122. This configuration provides for removal of a pill 122 by exerting pressure on the tray 124 in the direction of the backing material 126 until the backing material 126 is ruptured and the pill 122 is forced out of the tray 124.

Further referencing FIGS. 3 and 4, the apertures 100 of the fourth section 90 are configured to receive the trays 124, such that the trays 124 protrude through the apertures 100 when the package surface 125 abuts against the fourth section bottom face 92. This positioning allows the trays 124 to protrude through and extend beyond the fourth section top face 94, thereby providing accessibility to push a pill 122 inwards towards the backing material 126 for removal. The size, shape, number, and placement of the apertures 100 can be configured to accommodate various dimensioned packages 120 and/or pills 122, and therefore the size, shape, number, and placement of pills 122 can vary to convenience.

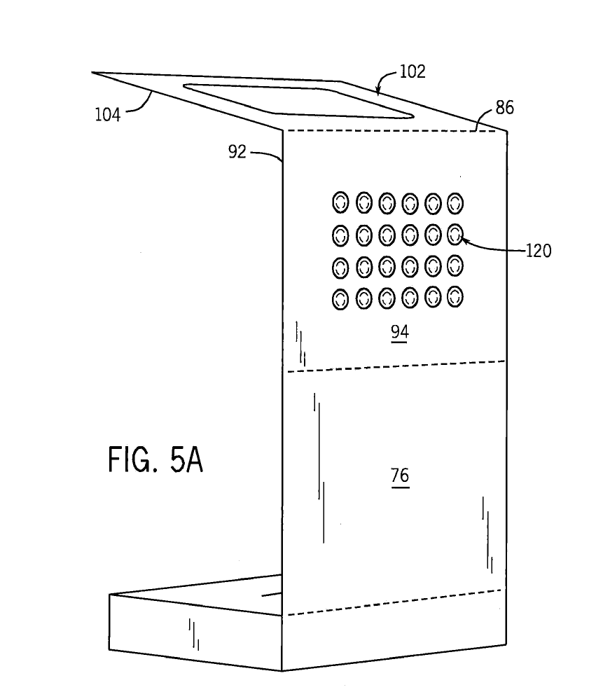

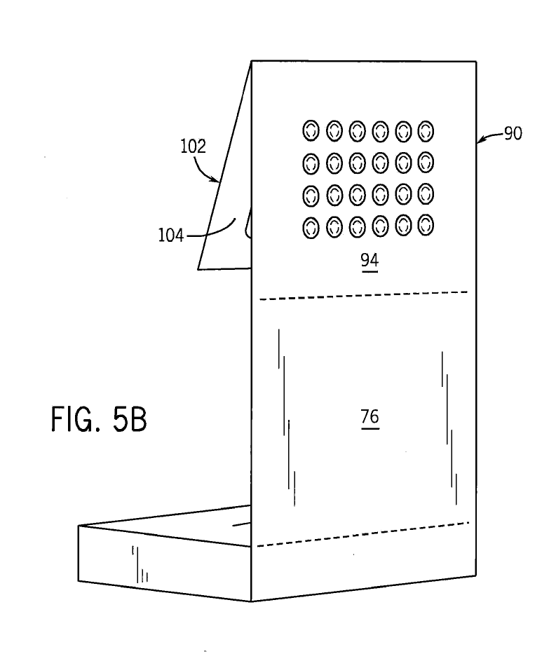

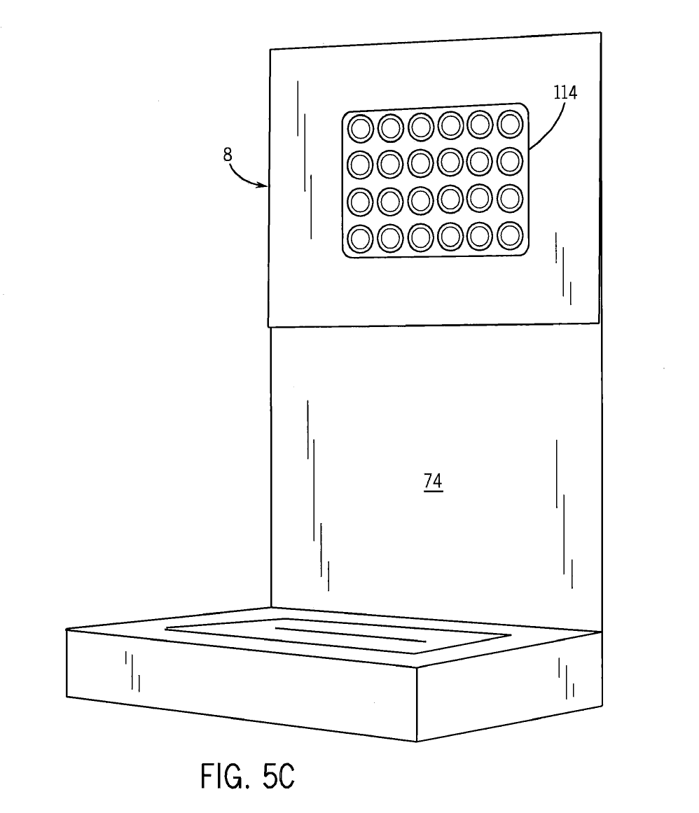

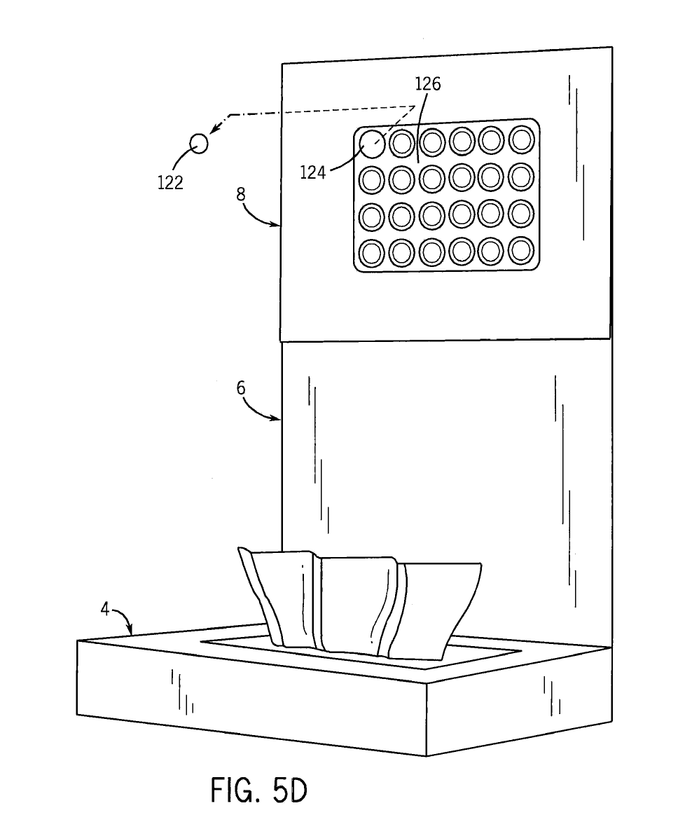

Referring to FIGS. 5A and 5B, in accordance with one embodiment, the package 120 is secured against the fourth section bottom face 92 by folding the fifth section 102 in a downward direction at line 86, such that the fifth section bottom face 104 (best shown in FIG. 2) abuts against both the fourth section bottom face 92 (best shown in FIG. 2) and at least a portion of the backing material 126 of the package 120, whereby the pill package 120 is sandwiched between the fifth section bottom face 104 and the fourth section bottom face 92. In at least some embodiments, the abutment of the faces 92, 104 can be secured by the use of an adhesive or another bonding material. Referring to FIGS. 5C and 5D, when assembled, the pill-dispenser portion 8 utilizes the opening 114 to provide access to the pills 122, whereby the pills 122 can be pressed through the backing material 126 and removed from the product dispenser 2 as shown in FIG. 5D.

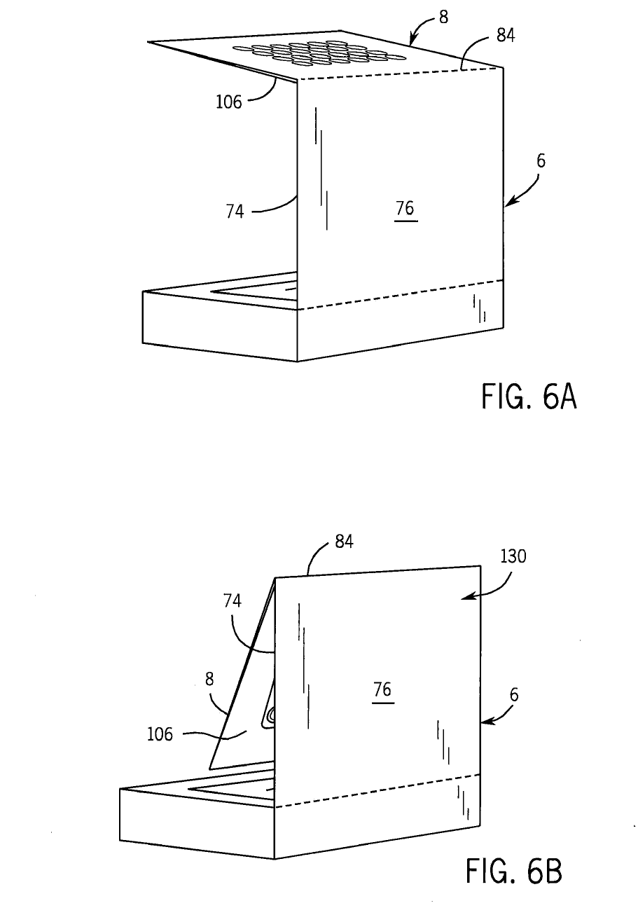

Referring now to FIGS. 6A and 6B, a cover 130 is formed by folding the pill-dispenser portion 8 at line 84 in a downward direction towards the cover portion 6, such that the fifth section top face 106 (best seen in FIG. 3) abuts against the third section bottom face 74 (as shown in FIG. 2). The third section bottom face 74 serves to cover and protect the backing material 126 to prevent or substantially prevent unintentional expulsion or removal of one or more pills 122.

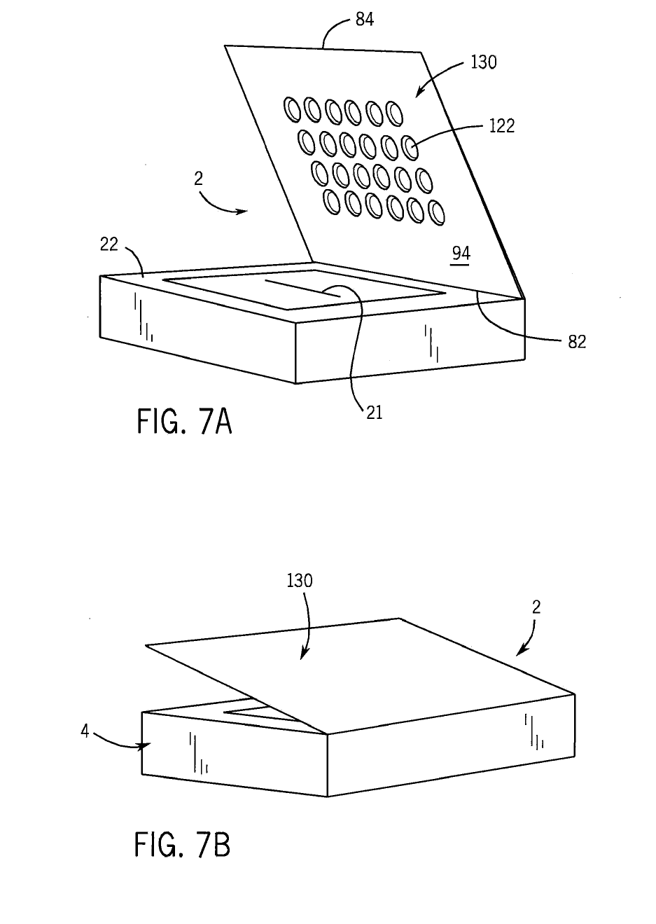

Referring to FIG. 7A, the cover 130 is depicted in an open position with respect to the tissue-dispensing portion 4. To move the cover 130 to a closed position, the cover 130 is folded downward at line 82 such that the fourth section top face 94 abuts against the first section top face 22. In this position the slot 21 is covered, to prevent or substantially prevent the unintentional removal or dispersal of any facial tissue 9. In addition, when the cover 130 is in a closed position, the pills 122 are removed from view to afford privacy to a user of the product dispenser 2. Also, in this position the product dispenser 2 can be easily transported.

The folding operations described herein need not take place in the particular order described, and any of various alternative orders is considered within the scope of the invention. Further, the folding can include simultaneous folding. Moreover, the folding operations can be manual or automated.

Although not required, a fastener such as a Velcro tab or a removable wafer seal can be used to secure the cover 130 in a closed position. When the cover 130 is in an open position, the product dispenser 2 provides convenient access to a facial tissue 9. Additionally, when the pill-dispenser portion 8 is subsequently unfolded from the cover portion 6 (as seen in FIG. 5D), access to a pill 122 is provided.

In addition to the dispensing of tissues 9 and pills 122, the product dispenser 2 can be utilized for signage. More particularly, the third section bottom face 74 (FIG. 5C) and the third section top face 76 (FIG. 3) of the cover portion 6 are configured to receive signage. Various types of signage, such as advertising logos or instructions for pill/medication use, can be imprinted, embossed or otherwise secured to the faces 74, 76. As the third section bottom face 74 is only exposed when the cover 130 is in an open position and the pill-dispenser portion 8 is unfolded, the third section bottom face 74 is ideal for signage that is not intended for general viewing (e.g., personal information or user-specific information). Whereas, the third section top face 76 is continuously exposed, even when the cover 130 is in a closed position. Therefore, the third section top face 76 can be utilized to display signage intended for general viewing (e.g., brand advertising). Although the faces 74, 76 are configured to receive signage, it has been contemplated that signage can be included on any surface of the product dispenser 2.

It is understood that invention is contemplated for use with any of a wide variety of encapsulated and non-encapsulated materials, including medications, and such materials can include both solid and/or liquid forms (e.g., a gel coating around a liquid material). Still, other materials (e.g., candy) that can be dispensed in the same or similar fashion as described herein are contemplated. Again, and in short, the invention should not be limited to any specific pill or pill-like structure. Further, although described as dispensing facial tissues and pills, in some embodiments, the dispenser can dispense other combinations of items, for example, small micro-fiberglass cleaning wipes, wipes with shoe shine material enclosed in the trays, wipes with treatments enclosed in the trays for use on automobile windows, and bodywork, baby wipes with trays of baby powder or Vaseline®, configured as a travel pack, feminine care packages with panty shields and trays enclosing body lotion, etc.

Although the assembled product dispenser 2 has been depicted in a rectangular box-like shape, other shapes, for example, cubed, rounded, cylindrical, hexagon, and wedge shapes can be formed. Further, although the blank 10 (unassembled product dispenser 2) has been described and shown as substantially rectangular and planar, the blank 10 can be formed into various shapes to convenience, to form a desired assembled product dispenser 2 shape. Further, although the product dispenser 2 has been described as being formed from a blank 10 that is a singular material forming seven sections, the blank 10 can be comprised of a plurality of discrete pieces and/or sections of one or more materials. In addition, the blank 10 has been described as a material having a substantially planar surface 11, although other embodiments can include non-planar surfaces. Additionally, as can be seen by the aforementioned description related to the products that are dispensed, the product dispenser 2 can be referred to as a multiple/dual product dispenser.

It is contemplated that the principles and teachings of the present invention can be applied to the blanks, containers, boxes, and/or dispensers as shown and/or described in one or more of the following patents and applications, each of which is incorporated by reference in its entirety herein: U.S. Pat. Nos. D568,763, D568,762, D556,053, D548,593, D546,675, D528,435, D526,897, D514,928, D505,069, D495,247, D494,859, 7,590,574 and 6,910,600, and U.S. Patent Publication No. 2005-0000976 A1.

It is specifically intended that the present invention not be limited to the embodiments and illustrations contained herein, but include modified forms of those embodiments including portions of the embodiments and combinations of elements of different embodiments as come within the scope of the following claims. Further, methods have been described and outlined in a sequential fashion. Still, modification, rearrangement, combination, reordering, or the like, of the methods is contemplated and considered within the scope of the appending claims.

We claim:

1. A product dispenser comprising:
a blank that is segregated into sections, wherein the sections are folded to form a first product dispensing portion for dispensing a first product, a second product dispensing portion for dispensing a second product, and a cover portion that is configured to receive signage, and
wherein the cover portion at least partially encloses both the first product dispensing portion and the second product dispensing portion.

2. The product dispenser of claim 1, wherein the blank is a single continuous piece of material.

3. The product dispenser of claim 2, wherein the blank is substantially planar.

4. The product dispenser of claim 2, wherein the first product includes a paper and/or fabric product.

5. The product dispenser of claim 2, wherein the second product includes a pill or pill-like product.

6. The product dispenser of claim 5, wherein the pill or pill-like product includes an encapsulated product.

7. The method of claim 5, wherein at least one of the first product dispensing portion, second product dispensing portion, and cover portion, includes a surface for receiving signage.

8. The product dispenser of claim 2, wherein the first product includes tissue paper and the second product includes at least one pill.

9. The product dispenser of claim 8, wherein the first product dispensing portion is box shaped and the cover portion is one of square shape or rectangle shaped.

10. The product dispenser of claim 2 in combination with the first product and second product being dispensed.

11. A product dispenser comprising:
a first section having at least one of a first section left flap portion and a first section right flap portion, and a slot formed therethrough for accessing a first product,
a second section having at least one of a second section left flap portion and a second section right flap portion, the second section connected to the first section by at least one of a front wall section and an end wall section,
wherein the front wall section includes at least one of a front wall left flap portion and a front wall right flap portion and the back wall section includes at least one of a back wall left flap portion and a back wall right flap portion, and wherein the securing of one or more of the first section flap portions, second section flap portions, front wall flap portions and back wall flap portions to each other provides an enclosure for the first product, a third section connected to at least one of the back wall section and the front wall section, wherein the third section forms at least a portion of a cover,
a fourth section having a plurality of apertures for receiving a plurality of trays at least partially therethrough, wherein the fourth section is connected to the third section, and
a fifth section having an opening for removing a second product situated in the trays when the fifth section is folded over the fourth section, wherein the fifth section and fourth sections form at least a portion of the cover and are capable of securing the trays when folded together, and whereby the cover is capable of covering the slot.

12. The product dispenser of claim 11, wherein the first product includes at least one paper-based product and/or fabric-based product.

13. The product dispenser of claim 11, wherein the second product includes at least one pill or pill-like product.

14. The product dispenser of claim 13, wherein the pill or pill-like product includes an encapsulated material.

15. The product dispenser of claim 11, wherein the first product is a paper and/or fabric product and the second product is a pill or pill-like product.

16. The product dispenser of claim 15, wherein at least a portion of the product dispenser is box shaped when assembled and the cover portion is one of a square shape or a rectangle shape.

17. A method of forming a multi-purpose product dispenser, the method comprising:
providing a continuous blank having a pill-dispenser portion and a tissue-dispenser portion, where the tissue-dispenser portion is connected to the pill-dispenser portion at least partially by a cover portion, and
assembling the multi-purpose product dispenser by folding at least a portion of each of the pill-dispenser portion, the tissue-dispenser portion and the cover portion.

18. The method of claim 17, wherein the pill-dispenser and tissue-dispenser portions can be used to dispense a pill-like structure and a paper-based product, respectively.

19. The method of claim 17, wherein the pill-dispenser and tissue-dispenser portions can be used to dispense a pill(s) and a tissue(s), respectively.

20. The method of claim 19, wherein the providing includes providing at least one signage-receiving surface on the blank.

21. A method of forming a product dispenser for pills and paper products comprising:
folding one or more flap portions of a first section of a blank, the first section having a slot formed therethrough for accessing a paper product,
folding one or more flap portions of a second section of the blank, the second section being connected to the first section by at least one of a front wall section and an end wall section of the blank,
folding one or more flap portions of the front wall section and the back wall section,
securing one or more of the first section flap portions, the second section flap portion, front wall flap portions and back wall flap portions to each other to enclose a plurality of paper products,
abuttingly positioning a pill package that includes one or more trays containing a plurality of pills against a fourth section of the blank, the fourth section having a plurality of apertures for receiving the plurality of trays at least partially therethrough, wherein the fourth section is connected to a third section,
folding a fifth section of the blank that is connected to the fourth section, such that the pill package is secured therebetween, wherein the fifth section includes an opening for removing a plurality of pills situated in the trays, and the fourth section is connected to a third section of the blank, and
folding the combined fifth section and fourth section onto the third section, and folding the combined fifth section, fourth section and third section onto the first section.
